(19) United States
(12) Patent Application Publication
(10) Pub. No.: US 2015/0040843 A1
(43) Pub. Date: Feb. 12, 2015

(54) WATER VAPOR MANAGEMENT AND CONTROL METHODOLOGY SYSTEM FOR SINGLE AND MULTIPLE HYDROGEN FUEL CELLS USED FOR COMBUSTION AUGMENTATION IN INTERNAL COMBUSTION ENGINES AND METHOD

(71) Applicant: Hydro Phi Technologies, Inc., Doraville, GA (US)

(72) Inventors: Jonathan Goldman, Marietta, GA (US); Doug King, Canton, GA (US); Reid Meyer, Newnan, GA (US); Chris Petty, Winder, GA (US); Basil Lee Winslett, Kennesaw, GA (US); Jackie Lee, Hoschton, GA (US)

(21) Appl. No.: 14/455,136

(22) Filed: Aug. 8, 2014

Related U.S. Application Data
(60) Provisional application No. 61/864,017, filed on Aug. 9, 2013.

(51) Int. Cl. F02B 43/12; F02M 21/02

(52) U.S. Cl. CPC F02B 43/12; F02M 21/0206; F02B 2043/106
USPC 123/3

(57) ABSTRACT

A system for managing moisture content of hydrogen and oxygen gas produced by a fuel cell for a fuel supplement for an internal combustion engine, with a tank holding process water and respective separate hydrogen and oxygen header spaces for receiving hydrogen and oxygen gas having moisture content wherein some moisture content forms droplets and falls into the process water yielding dried hydrogen and oxygen gases for communicating through supply lines to the engine as a fuel supplement during operation. A method is disclosed for managing moisture content of hydrogen and oxygen gas produced by a fuel cell for delivery as a fuel supplement to an engine.

### TECHNICAL FIELD

The present invention relates to apparatus and methods for providing supplemental fuel to internal combustion engines. More particularly, the present invention relates to apparatus and methods of managing and controlling moisture in constituent hydrogen and oxygen gas streams generated by fuel cells for fuel supplements provided to internal combustion engines.

### BACKGROUND OF THE INVENTION

The present invention relates generally to the management and control of moisture, generally in the form of water vapor in fuel cells run in the reverse direction (to dissociate water into it gaseous constituents) or in traditional Faraday electrolysis cells used for creating on-demand fuel additives for improved performance in internal combustion engines.

Fuel cells run in the reverse direction have been used to generate pure hydrogen and oxygen in an on-demand fashion. In certain designs, these electrolyzers have allowed the gases produced (H₂ and O₂) to mix within the cell manifold and emerge as mixed, rather than separated, gases, which then serve as a fuel additive to traditional hydrocarbon fuels.

More traditional electrolysis cells, which rely on a liquid electrolyte (typically acidic or basic) have been used to generate on-demand mixed-gas fuel additives known severally as ‘oxy-hydrogen,’ ‘hydroxy,’ ‘HHO,’ or ‘Brown's Gas’ for use as a fuel additive to traditional hydrocarbon fuels in traditional internal combustion engines.

Since these reactions occur at elevated temperatures above ambient, typically somewhere between room temperature and the boiling point of water, there is a significant amount of moisture in the form of water, and the water vapor generated may end up in the one or more gas streams introduced into the engine along with the fuel additive. The existence of the moisture-laden gas stream(s) has three important system design implications: i) a method for returning liquid-phase water is needed to ensure water consumption is minimized; ii) a method for minimizing water vapor in the gas supply line(s) is needed in order to prevent significant condensation in the supply line(s) so as to avoid blocking the gas path to the engine air intake, and iii) a method for controlling the moisture in the gases forming the fuel additive is important for regulating the combustion process. These will be discussed in turn.

i) Returning Liquid-Phase Water to Minimize Water Consumption

Both reverse fuel cells (PEM electrolyzers) and traditional electrolyzers incorporate circulation pumps to introduce either pure, distilled water (in the case of PEM electrolyzers) or an electrolyte-water mix into the cells where they are subjected to a current. In both cases, the process gases are mixed with water in the pumped loop and must be separated. In the case of PEM electrolyzers, there is a significant amount of water that is exhausted along with the pure oxygen gas. The water must be returned to the system for recirculation, otherwise water consumption will be unacceptably high. As hydrogen is generated and passes across the proton exchange membrane, there is a much smaller quantity of water taken along with it across the membrane through what is known as electroosmotic drag. Thus, there is also some water present in the H₂ gas stream. Both streams should have the maximum amount of water possible returned to the process water tank.

It is common in traditional PEM electrolyzer installations as well as ordinary Faraday chemical electrolysis applications to see methods that involve a collecting vessel or chamber where the liquid/gas stream could be sprayed into and where the liquid could collect and be drawn downward via gravity past a seal that would separate the process water tank from the process gas. It is also common to find systems where the process liquid (pure distilled water for PEM electrolysis or a water/electrolyte mix for traditional electrolysis) is in communication with the exhaust gas stream. In this case, the product gas stream is bubbled through the process liquid to a) trap any residual process liquid in the vapor phase, and b) in the case of traditional electrolysis, scrub out any electrolyte chemicals from the gas phase before entering the engine cylinder. The design and construction of these collection or gas separation chambers must be such that either any splashing of liquid as it spills into this return chamber or any disruption of the liquid surface due to bubbles escaping is minimized and doesn't allow for liquid to escape into the gas lines to the engine. If care is not taken, too much liquid might splash into gas supply lines and cause an unacceptably high use of water in the process.

ii) Minimizing Water Vapor in the Gas Supply Line(s)

Additionally, it is important to control the level of moisture in the gas supply lines to manage the level of condensation in the lines on their way to the air intake of the engine. If gas supply lines are not positioned to provide a continuous upward slope between the gas separator and the air intake, there will, therefore, be a low-spot in the supply line that might allow for liquid condensate to collect, thereby creating another bubbling zone, which might impede the delivery of gas to the engine. Furthermore, there is a risk for this pooled liquid to freeze in cold weather, thereby blocking gas flow and risking a build-up of gas pressure if there is no pressure relief mechanism or pressure monitoring and safety interlocking mechanism.

Systems that are designed to provide this continuous upward slope can generally only achieve this by positioning the system near the engine in the engine compartment, which places severe volumetric and thermal management constraints on the system, and are therefore undesirable. Many systems aren't small enough to comfortably fit in the engine compartment. As a result, their designs provide for mounting behind the cab somewhere on the frame of the truck, or in an auxiliary battery box, which cannot insure a continuous upward slope of the gas supply lines and therefore may suffer the possibility of liquid pooling within the supply line. It is therefore critical for humidity levels in the process gas lines to be well managed to avoid this liquid pooling potential.

iii) Controlling Moisture in the Fuel Additive

Finally, process gas humidity management is important for managing the combustion dynamics as hydrogen and oxygen are introduced to augment the air provided to the fuel in the cylinders. Since the flame speed for hydrogen is approximately nine times that of diesel fuel, the conditions around the introduction of hydrogen gas are critical for achieving a desired catalytic improvement in diesel efficiency. There are several parameters that may be manipulated to optimize this effect:
1. the amount of hydrogen and oxygen that are added to the air going into the cylinder;
2. the temperature at which the hydrogen and oxygen is introduced;
3. the relative ratio of the hydrogen and oxygen that are added to the air going into the cylinder, and
4. the relative humidity at which the hydrogen and oxygen is introduced.

Each of these parameters have drawbacks to its application for achieving catalytic improvement of an internal combustion engine. The amount of hydrogen and oxygen added is a function of the power applied to the electrolyzer and its relative electrical efficiency. Control of this amount depends on the desired volume of hydrogen introduced.

The temperature of the fuel-additive gas (or gases) will, generally speaking, be a function of the electrolyzer temperature, the amount of insulation in the gas line(s) and the external environmental temperature.

The relative ratio of hydrogen and oxygen is always fixed, unless manipulated in a mechanism such as a bleed orifice in one or both gas lines. Ratio manipulation presents structural, operation, and control difficulties and drawbacks in a fuel supplementation system for internal combustion engines.

Finally, the relative humidity of the process gas (or gases) may be affected by system design parameters. Too much humidity and the process gases may produce too much condensate in the gas supply lines. Too little humidity and the hydrogen may combust prematurely, and may, therefore, not be well-matched with cylinder diesel fuel injection timing.

Accordingly, there is a need in the art for an improved apparatus and method with a control system for managing the humidity as is typically emitted as part of the process of gas generation from traditional electrolytic and reverse fuel cell (or PEM) electrolyzers, for generating hydrogen and oxygen gases for a supplemental fuel for internal combustion engines. It is to such that the present invention is directed.

### SUMMARY OF THE INVENTION

The present invention meets the need in the art for an apparatus and method with a control system for managing the moisture typically emitted as part of the process of gas generation from fuel cells (traditional electrolytic and reverse fuel cell (or PEM) electrolyzers), for generating hydrogen and oxygen gases for a supplemental fuel for internal combustion engines. More particularly, the present invention provides a system for managing moisture content of hydrogen and oxygen gas produced by a gas generator apparatus for delivery as a fuel supplement to an intake manifold of an internal combustion engine. The system comprises a supply body for holding a volume of a process water and an apparatus for generating hydrogen gas and oxygen gas from a flow of the process water, the generated hydrogen gas and generated oxygen gas each having a respective first moisture content. A hydrogen header space in the supply body receives the generated hydrogen gas therein and communicates therefrom a dried hydrogen gas, wherein at least some of the moisture content of the generated hydrogen gas forms droplets and falls into the supply of process water within the supply body yielding the dried hydrogen gas having a second moisture content, the second moisture content less than the first moisture content thereof. An oxygen header space in the supply body receives the generated oxygen gas therein and communicates therefrom a dried oxygen gas, wherein at least some of the moisture content of the generated oxygen gas forms droplets and falls into the supply of process water within the supply body yielding the dried oxygen gas having a second moisture content, the second moisture content less than the first moisture content thereof. A hydrogen gas supply line provides for communicating the dried hydrogen gas to an intake manifold of an internal combustion engine for a fuel supplement during operation of the internal combustion engine; and an oxygen gas supply line provides for communicating the dried oxygen gas to an intake manifold of an internal combustion engine for a fuel supplement during operation of the internal combustion engine.

In another aspect, the present invention provides a method for managing moisture content of hydrogen and oxygen gas produced by a gas generator apparatus for delivery as a fuel supplement to an intake manifold of an internal combustion engine, comprising the steps of:

(a) providing a flow of process water from a supply thereof held within a supply body to an apparatus for generating hydrogen and oxygen gas;

(b) generating from the process water separate flows of hydrogen gas and oxygen gas each having a respective first moisture content;

(c) communicating the moisture content hydrogen gas to a hydrogen low pressure header space within the supply body, wherein at least some of the moisture content thereof forms droplets and falls into the supply of process water within the body yielding a dried hydrogen gas having a second moisture content, the second moisture content less than the first moisture content thereof;

(d) communicating the moisture content oxygen gas to an oxygen low pressure header space within the body, wherein at least some of the moisture content thereof forms droplets and falls into the supply of process water within the body yielding a dried oxygen gas having a second moisture content, the second moisture content less than the first moisture content thereof; and

(e) communicating the dried hydrogen gas and the dried oxygen gas to an intake manifold of an internal combustion engine for a fuel supplement during operation of the internal combustion engine.

The inventors of the present invention have recognized the shortcomings of gas delivery systems in designs for traditional mixed-gas chemical electrolyzers as well as PEM-based electrolyzers when applied to fixed or mobile diesel engines for the purposes of improving either fuel efficiency or reducing emissions. It has been found that it would be advantageous to use the system's water supply tank as an expansion vessel to simultaneously achieve a drop in gas temperature, which automatically results in a substantial drop in relative humidity in the gases. The ‘headspace’ in the supply tank is large enough to represent a substantial drop in pressure thus facilitating the condensation of water vapor back to the liquid phase. Further, it has been found to be advantageous to provide for a small, secondary chamber or chambers in communication with the water supply tank headspace that may serve to further reduce humidity through the use of a water vapor filter material.

The system includes one or more tanks for supply water that is in communication with one or more electrolyzers. In traditional, mixed-gas electrolyzers, the size and shape of the expansion is less critical as all process gases will fill the entire headspace. However, it is critical in PEM electrolyzer systems to control the size and shape of the respective hydrogen and oxygen expansion tanks to ensure the gases emerging from the stack or stacks may do so in an unimpeded fashion.

As the gases must always emerge from the stack or stacks in a consistent proportion, that is, two moles of hydrogen gas to one mole of oxygen gas, it is important to provide twice the expansion volume for hydrogen as is available for oxygen. This is to ensure there is no backpressure on either side of the stack and that gas production can occur normally. Thus, the system as designed, provides a headspace in the hydrogen expansion tank that is precisely twice as large as the headspace available in the oxygen expansion tank.

Further, it is a goal of the present invention to optimize system design so as to minimize installation footprint. As a result, the system includes a tank design that combines the gas expansion function from 2 separate containers into an integrated ‘split tank’ solution. The respective gases (hydrogen and oxygen), introduced into their respective tanks, expand and then allowed to escape into small secondary vapor traps that further reduce moisture before introducing the gases into the air intake manifold of the engine through separate gas lines, or alternative, that recombine in a fixture or manifold that connects directly to the air intake.

Objects, advantages, and features of the present invention will be apparent upon a reading of the following detailed description in conjunction with the drawings and the appended claims.

### BRIEF DESCRIPTION OF THE DRAWINGS

FIG. 1 illustrates in side view an exemplary embodiment of a system for fuel cell (reverse fuel cell or PEM electrolyzer) generation of hydrogen and oxygen gas supplied through a moisture dryer to an intake manifold of an internal combustion engine as supplemental fuel in accordance with the present invention.

FIG. 2 illustrates a detailed side view of a mounting base for the system illustrated in FIG. 1 while illustrating an alternate embodiment of a dual-tank process water supply tank defining header spaces in which the hydrogen and oxygen gases from the electrolyzer process collect.

FIG. 3 illustrates an alternate embodiment of a system for fuel cell (reverse fuel cell or PEM electrolyzer) generation of hydrogen and oxygen gas supplied through a second moisture dryer after the hydrogen and oxygen gases expand into separate head-spaces of the process water supply tank to an intake manifold of an internal combustion engine as supplemental fuel in accordance with the present invention.

FIG. 4A illustrates the outlet tubing that transports the hydrogen and oxygen gases and liquid back to the headspace of the process water supply tank where the gases expand and cool as an initial gas dryer.

FIG. 4B illustrates a cut-away view taken along line 4B-4B of FIG. 4A showing the split-dual process water supply tank.

FIG. 5A illustrates in a ‘bottoms-up’ view the alternate embodiment process water supply tank illustrated in FIG. 2 showing a smaller tank or chamber disposed within a larger tank or chamber volume and attached to the lid of the process water supply tank.

FIG. 5B illustrates a cut-away view taken along line 5B-5B of FIG. 5A showing the dual-tank process water supply tank.

FIG. 6A illustrates an alternate embodiment of a process water supply tank in which respective hydrogen and oxygen exhaust ports are located proximate to each other to facilitate the routing of tubes that communicate the hydrogen and oxygen gases to the vapor traps for drying prior to communicating the dried hydrogen and oxygen gases to the intake manifold of an internal combustion engine.

FIG. 6B illustrates in top plan view the process water supply tank illustrated in FIG. 6A.

FIG. 7 illustrates a detailed portion of an alternate embodiment of the system for fuel cell (reverse fuel cell or PEM electrolyzer) generation of hydrogen and oxygen gas supplied through a first and a second moisture dryer to an intake manifold of an internal combustion engine as supplemental fuel in accordance with the present invention, in which the second moisture dryer includes finned metallic surfaces or vanes that provide a large cold surface area upon which moisture droplets condense.

FIG. 8 illustrates an alternate embodiment of a second moisture dryer for the system for fuel cell (reverse fuel cell or PEM electrolyzer) generation of hydrogen and oxygen gas supplied through the second moisture dryer after the hydrogen and oxygen gases expand into separate head-spaces of the process water supply tank to an intake manifold of an internal combustion engine as supplemental fuel in accordance with the present invention.

FIG. 9 illustrates in partially cut-away view an alternate embodiment of a second moisture dryer having coaxial first and second sleeves each having a plurality of openings and the sleeves movable relative to each other to adjust the openings for passage of the hydrogen and oxygen gas through the sleeves into contact with the coalescing material.

FIG. 10 illustrates in partially cut-away view an alternate embodiment of a second moisture dryer having coaxial first and second sleeves each having a plurality of openings and the sleeves movable relative to each other to adjust the openings for passage of the hydrogen and oxygen gas through the sleeves into contact with the coalescing material.

### DETAILED DESCRIPTION

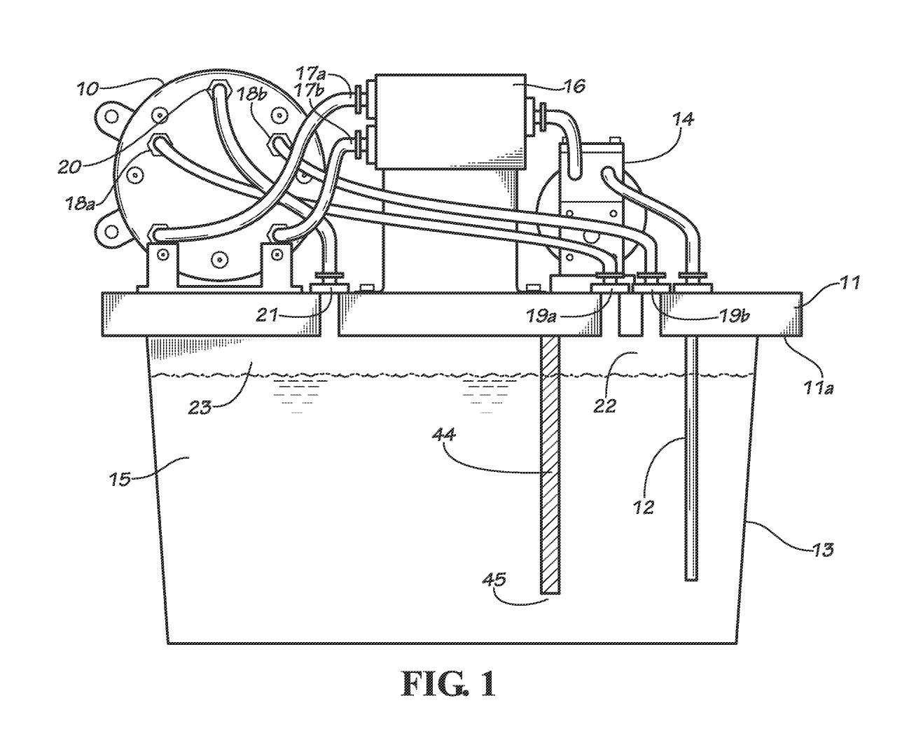

With reference to the drawings, in which like part have like reference numerals, FIG. 1 is an exemplary representation of a system configuration that shows a reverse fuel cell or PEM electrolyzer 10 that is mounted to a plate 11 that serves as a base for attaching gas and fluid distribution tubing as well as process water pumping and filtration services. A water pick-up tube 12 extends down into the water supply tank 13 that is attached to the underside 11a of the mounting plate 11. The water pick-up tube 12 feeds the PEM electrolyzer through a process liquid pump 14 directly, or preferably, after sending the process liquid (distilled water) —15 through a liquid filter 16. The output of the pump or filter may be a single line or several lines depending upon the design of the PEM stack. In this exemplary representation, the PEM electrolyzer has two water process inputs 17a, 17b. The system also has two oxygen process gas outputs 18a, 18b. These outputs may be combined before being introduced into the head-space of the oxygen side of the water tank, but preferably are introduced via two gas ports 19a, 19b in order to avoid any possibility for back-pressure to the PEM stack. Concomitantly, hydrogen process gas exits the stack through a hydrogen output 20, and is introduced into the head-space of the hydrogen side of the water tank through a hydrogen gas port 21.

As the oxygen transits the mounting plate, it is exhausted into the head-space 22 of the oxygen side of the water tank 13, where the oxygen gas expands, cools and drops moisture back into the process water beneath held in the process liquid supply tank. Similarly, as the hydrogen transits the mounting plate, it is exhausted into the headspace 23 of the hydrogen side of the water tank 13, where it expands, cools and drops moisture back into the water beneath. A barrier 44 extends from the mounting plate 11 to a free distal end leaving a gap 45 between the distal end and a bottom of the supply tank 13. The barrier 45 maintains the head-spaces 22, 23 separate while the gap 45 permits fluidic communication of the process water within the tank 13. It is to be appreciated that the fuel cell 10 generates the hydrogen and oxygen gas at a first pressure, generally about 3 psi above ambient, and the respective oxygen and hydrogen header spaces 22, 23 are at a second pressure that is less than the first pressure.

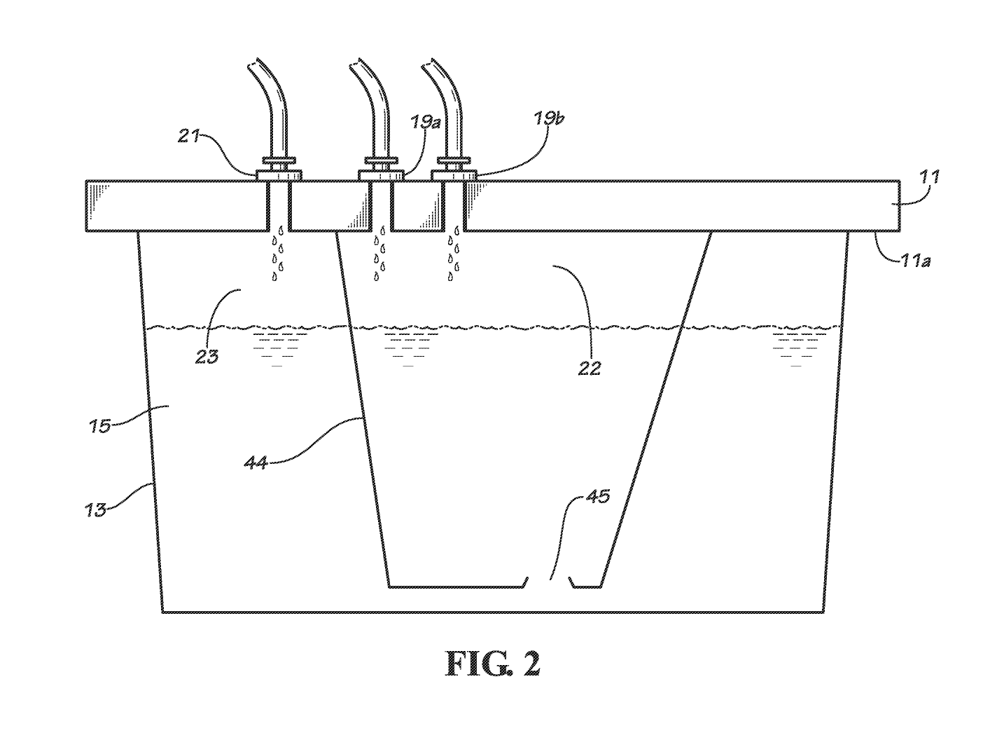

FIG. 2 is an exemplary representation of the underside 11a of the mounting base 11, or tank lid, that shows how the hydrogen and oxygen gases are allowed to expand where they cool and return moisture to the process water 15 in the tank 13. The gases are maintained separately as the water tank 13 contains the barrier 44 that prevents communication between the respective oxygen and hydrogen headspaces 22, 23 on opposing sides of the barrier. FIG. 2 further illustrates an alternate embodiment of a dual-tank process water supply tank 13 with a first hydrogen side tank containing an oxygen side tank in its interior, each for defining respective header spaces 22, 23 in which the hydrogen and oxygen gases from the electrolyzer process collect.

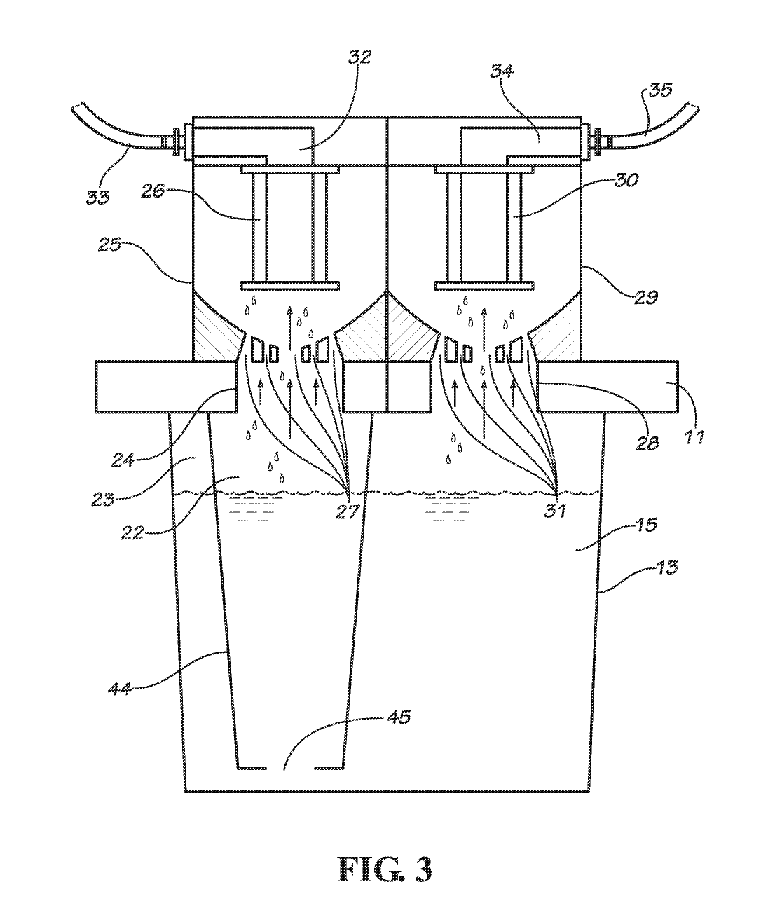

FIG. 3 is an exemplary representation of how the hydrogen and oxygen gases are further dried after expanding into the headspaces 22, 23 of the respective oxygen and hydrogen sides of the tank 13. In this example, oxygen is allowed to transit through the tank lid 11 through a hole 24 that is sealed against a small chamber oxygen vapor trap 25 seated on the top-side of the tank lid. In the illustrative embodiment, the oxygen vapor trap 25 contains coalescing filter material 26 that returns moisture droplets to the bottom of the oxygen vapor trap. The droplets return to the water tank 13 via gravity through one or more small orifices 27. Similarly, hydrogen is allowed to transit back through the tank lid 11 through a hole 28 that is sealed against a small chamber hydrogen vapor trap 29 seated on the top-side of the tank lid 11. The hydrogen vapor trap in the illustrative embodiment contains coalescing filter material 30. Moisture droplets fall to the bottom of the hydrogen vapor trap 29 and return to the water tank 13 via gravity through one or more small orifices 31.

Gases passing through the oxygen vapor trap 25 are allowed to then escape through a gas manifold orifice 32 that connects to an oxygen gas line 33 that connects to the air intake manifold of the engine. Gases passing through the hydrogen vapor trap 29 are allowed to then escape through as gas manifold orifice 34 that connects to a hydrogen gas line 36 that connects to the air intake manifold of the engine.

Reference will now be made to the exemplary embodiments illustrated in the drawings, and specific language will be used herein to describe the same. It will be understood that no limitation in scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described generally herein provide for a method and a system for managing and controlling the amount of moisture that is delivered with supplemental fuel to an internal combustion engine that can run on any hydrocarbon fuel, which supplemental fuel is generated by one or more electrolytic cell stacks that use either a chemical approach (traditional Faraday electrolysis) or a Proton Exchange Membrane (PEM) stack for splitting water into hydrogen and oxygen. In the case of a traditional Faraday electrolyzer, the process generally results in a mixed gas product, referred to commonly as ‘oxy-hydrogen,’ ‘hydroxy,’ ‘HHO,’ or ‘Brown's gas’ that is generated by the electrolyzer stack and is delivered to the engine in a single delivery tube or flexible hose, although in alternate embodiments, the stack designs provide for capturing the hydrogen and oxygen gas byproducts individually. In this latter case, the separate gases are delivered to the engine air intake manifold via two separate tubes or hoses, which may enter the intake manifold through two individual ports or alternatively, may be recombined and enter the intake manifold through a single port. In the case of a PEM electrolyzer, the process generally results in separate hydrogen and oxygen outputs, and these are delivered to the engine via two separate tubes or hoses, which may enter the intake manifold through two individual ports or may be recombined and enter the manifold through a single port, although in an alternate embodiment, the stack design combines the hydrogen and oxygen gas byproducts. In this latter case, the combined gases are delivered to the air intake manifold via a single tube or hose, which enters the intake manifold through a single gas port.

As the process water is split by the electrolysis process, the gaseous hydrogen and oxygen escape the stack 10, either singly as a combined gas through a single tube or hose or separately through separate tubes or hoses. When the gases escape, however, the gases are generally accompanied by a certain amount of moisture and water vapor. The amount of moisture or water vapor is a function of the temperature and pressure of the cell 10 or stack. For traditional electrolyzer stacks, the moisture and water vapor are contained in the single tube or hose that carries the HHO or hydroxy to the engine air intake manifold. In the case of PEM electrolyzers, there is usually more moisture and water vapor accompanying the oxygen gas in the oxygen tube or hose than will be found in the hydrogen tube or hose due to the separation function of the PEM membrane.

To supply the traditional electrolyzer or PEM stack, the process water supply tank 13 is available from which process water 15, such as tap water and a suitable electrolyte, or in the case of a PEM stack, pure distilled water, is pumped by the pump 14 into the intermediate filter 16 and then into the stack 10. The stack 10 may receive the process water 15 from the water filter 16 via tubing or hose. In the preferred embodiment, the PEM stack is fed by a pair of water inlets. Water passes through the stack and a mix of water, oxygen gas and water vapor is received in a pair of exit tubing or hoses. A third exit port receives hydrogen gas, along with a small portion of moisture due to the electroosmotic drag intrinsic to PEM stack designs.

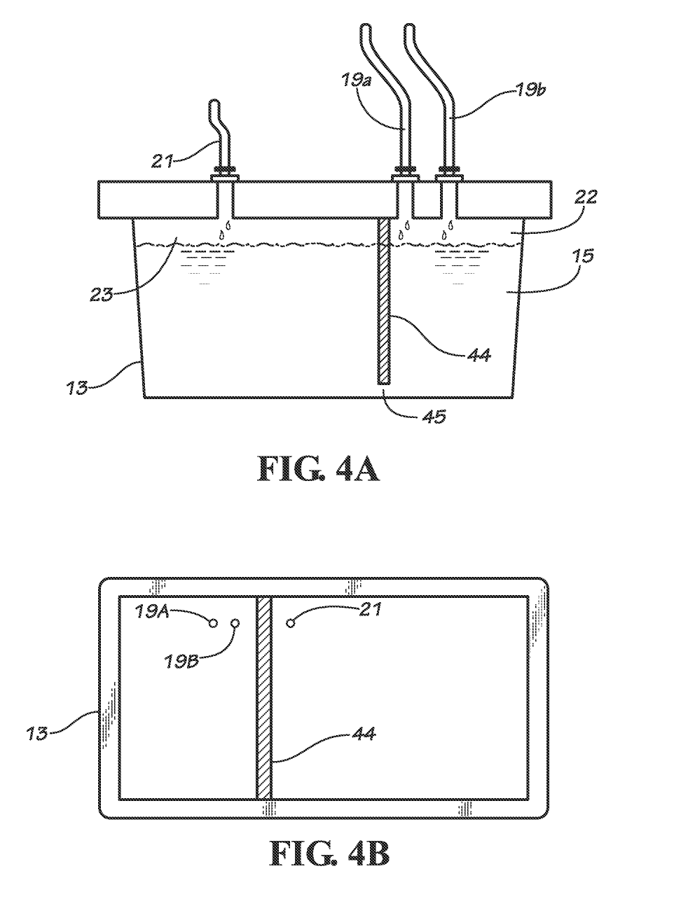

Referring to FIGS. 4A and 4B, the illustrative embodiment in one aspect, shows how the oxygen outlet tubing 19a, 19b transports the gas and liquid back to the headspace 22 of the water tank 13, where the oxygen gas expands and cools. This expansion and cooling has the effect of removing a large fraction of moisture from the oxygen gas streams and returning the moisture to the water tank 13 for re-use. Commensurately, the same FIGS. 4A and 4B show how the hydrogen outlet tubing 21 transports the hydrogen gas to the headspace 23 of the water tank 13, where the hydrogen gas expands and cools. This expansion and cooling has the effect of removing a large fraction of any residual moisture from the hydrogen gas stream and returning the moisture to the water tank 13 for re-use. It is critical to note in this aspect that the barrier 44 divides the headspaces 22, 23 of the water tank 13 to prevent the mixing between oxygen and hydrogen gas streams. The result is that the tank 13 is split with the barrier 44 that separates the headspace 22, 23 in the tank and extends nearly all the way to the bottom of the tank. The small gap 45 is preserved between the bottom edge of the water tank barrier 44 and the bottom of the tank 13 to enable fluid communication between the two sides (the oxygen side and the hydrogen side), yet prevent gas communication in the headspaces 22, 23, even in the event of sudden accelerations and decelerations, whether in the direction of motion or laterally, as during banking turns of a motor vehicle. Further, it is crucial that the volumes of the respective oxygen and hydrogen headspaces 22, 23 are designed specifically to be in the proportion of 1:2 so as to reflect the relative molar volumes of the oxygen and hydrogen gases produced by electrolysis. This is necessary to ensure equivalent gas pressures in the oxygen and hydrogen lines so stacks may function properly.

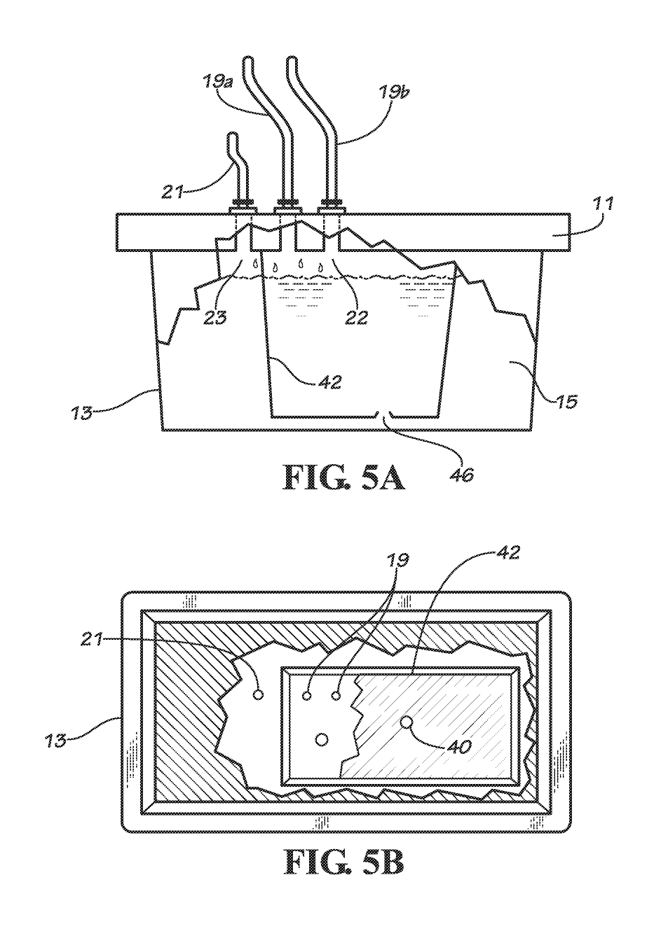

In another embodiment, referring to FIGS. 5A and 5B, the water tank 13 is not split longitudinally or vertically when viewed from above, but rather a smaller chamber 42 is disposed within the larger tank 13 volume and joined to the lid 11 of the tank by one or more of several methods, such as by gluing or by sealing to the surface of the tank lid via one or more gaskets. In this embodiment, this inner tank 42 extends down into the supply of process water 15 and nearly all the way to the bottom of the tank. A small gap is preserved between the bottom edge of the inner tank barrier 42 and the bottom of the tank 13 with a water communication port 46 to enable fluid communication between the two sides, yet prevent gas communication in the header spaces 22, 23, even in the event of sudden accelerations and decelerations, whether in the direction of motion or laterally, as during banking turns. The shape of this inner tank may be arbitrary, though depicted in this embodiment as having a rectangular shape, when viewed from above. As in the previous embodiment, the relationship between the respective oxygen and hydrogen headspaces 22, 23, respectively, between the lid or mounting plate 11 and the inner and outer tanks 42, 13 must always preserve a ratio of 1;2. It is arbitrary as to whether the inner tank dimensions define the larger or smaller headspace. What is critical is that the oxygen must always be expanded into the smaller 22 of the two headspaces 22, 23, while the hydrogen must always be expanded into the headspace 23 of the larger tank volume.

As the gas or gases are expanded into the tank or tanks, again, depending upon whether there are mixed gases or separate gases present, they must then be removed from the headspace 22, 23 of the tank and delivered to the intake manifold in the manner described above. In one embodiment, the gases may be vented to separate ports on the surface of the tank lid 11, and then fed via tubing or hose to the air intake manifold. In this embodiment, the oxygen exhaust port 24 in FIG. 3 is disposed somewhere on the surface of the tank lid 11 that is over the oxygen tank headspace 22, and the hydrogen exhaust port 28 in FIG. 3 is disposed somewhere on the surface of the tank lid 11 that is over the hydrogen tank headspace 23.

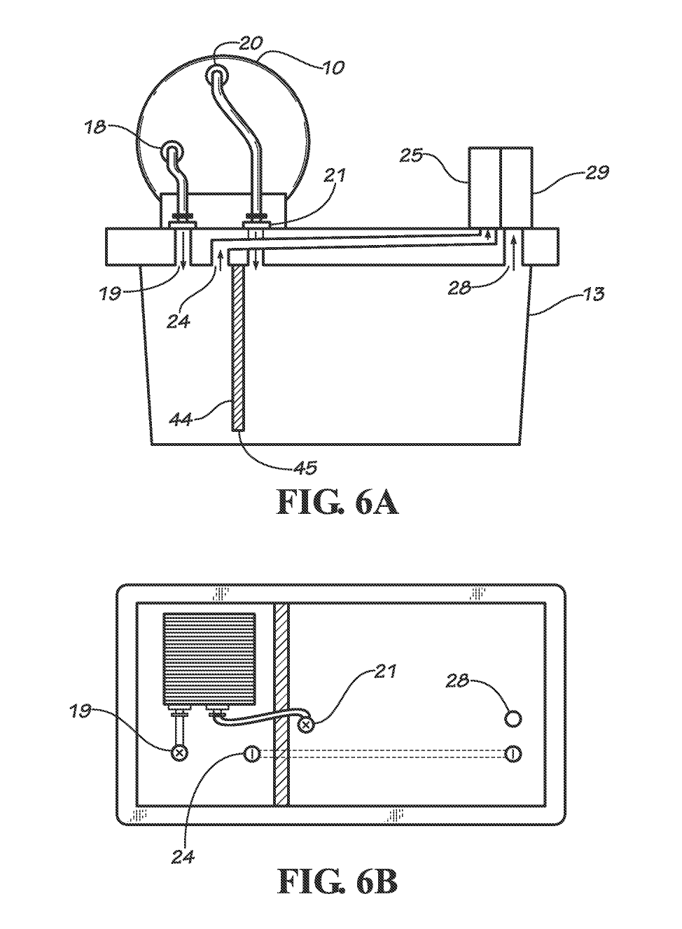

It is sometimes advantageous to reduce or eliminate tubing or hoses that transport the gases in order to provide for more efficient routing of gases out of the system. In yet another embodiment, the respective exhaust gas ports do not need to directly transit the tank lid 11 above their respective tanks. Gas ports that communicate with their respective tanks may be disposed within the tank lid or along the surface of the tank lid. FIG. 6 shows how the oxygen and hydrogen exhaust ports may be brought proximate to each other from different sides of the tank in order to facilitate the routing of gases without resorting to tubing or hoses transiting laterally across the surface of the tank lid.

In yet another embodiment illustrated in FIG. 3, the system provides for a further drying of the hydrogen and oxygen gases to further reduce moisture content within the gas streams, as may be necessary. This may be accomplished by disposing the oxygen vapor trap 25 that is sealed to the surface of the tank lid 11 (such as through an appropriate gasket that encircles the oxygen exhaust port 24). The oxygen vapor trap 25 contains the chamber with small holes 27 that simultaneously provide a passage for the oxygen in its respective headspace 22 to expand into, as well as multiple orifices 27 for moisture collected within the trap to transit back down to the tank 13 underneath. The holes 27 may be of arbitrary size, shape and number as long as they are disposed in the bottom portion of the trap 25, and do not extend beyond the perimeter of the seal between the trap and the tank lid 11. Similarly, the hydrogen vapor trap contains the chamber 29 with small orifices 31 that simultaneously provide a passage for the hydrogen from its respective headspace 23 to expand into, as well as multiple holes for moisture collected within the trap 29 to transit back down to the tank 13 underneath. The holes may be of arbitrary size, shape and number as long as they are disposed in the bottom portion of the trap 29 and do not extend beyond the perimeter of the seal between the trap and the tank lid 11. These traps 25, 29 may exist individually or may be fashioned from a single body of material, preferably a suitable plastic compatible with the process fluid (distilled water in the case of a PEM stack). When fashioned from a single body of material, it is critical to place the traps suitably so as to straddle the two sides of the water tank so that the oxygen and hydrogen gas within their respective headspaces 22, 23 communicate appropriately with their respective vapor traps 25, 29. Once expanded into their respective gas traps, the oxygen and hydrogen may connect to their respective tubes or hoses 33, 35 to be inducted into the engines air intake through a suitable gas exit port 32, 34.

In yet another embodiment, the oxygen and hydrogen gas traps 25, 29 may have disposed within them filter materials of various types including, but not necessarily limited to pleated, filamentary or porous materials to act as barriers against the passage of moisture and water vapor into the oxygen and hydrogen gas lines 33, 35 respectively. These filter materials will act to coalesce moisture and water vapor into droplets that will be pulled by gravity downwards until they drop to the bottom of the vapor trap, and transit the orifices (27, 31) to re-enter the water tank 13 below. In the preferred embodiment, the filter 26, 30 would be cylindrical and sealed against the trap housing such that the high-pressure side of the filter is in fluid communication with the headspace 22, 23, while the low-pressure side of the trap is in fluid communication with the gas exit port 32 for the oxygen vapor trap 25, and the gas exit port 34 for the hydrogen vapor trap 29, respectively. The filter materials may be TEFLON material, polypropylene or polyethylene, or other material having suitable porosity or pore size to enable the gas to escape, yet promote the nucleation of water drops that fall back to the process water supply via gravity and that the material is chemically robust against warm, distilled water of high purity.

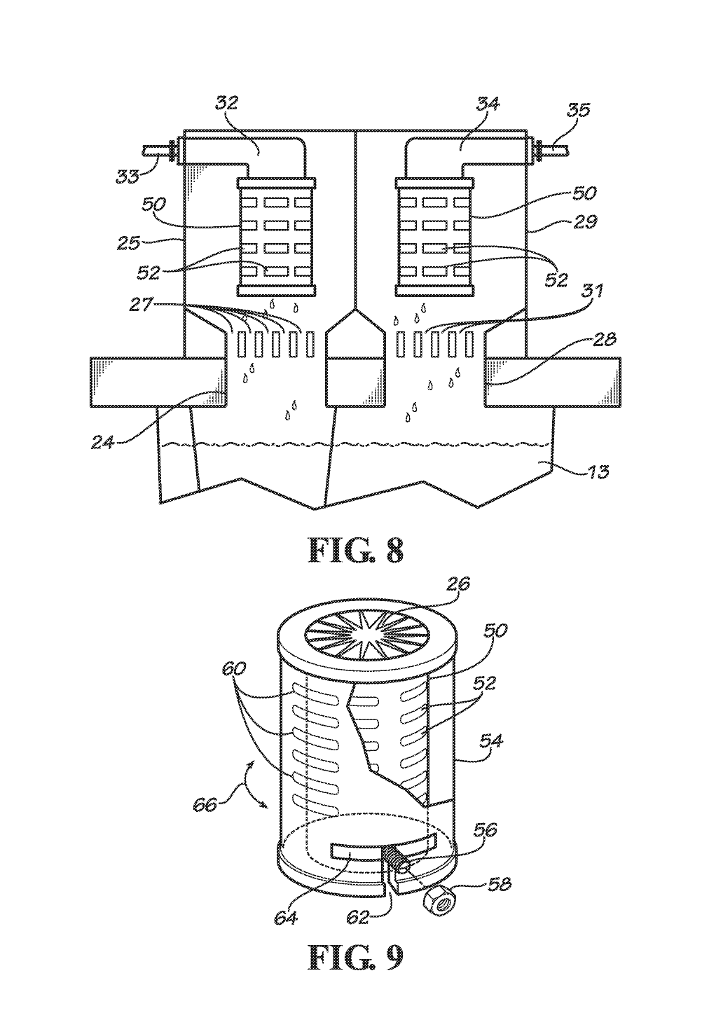

FIG. 8 illustrates an alternate embodiment of a second moisture dryer for the system for fuel cell (reverse fuel cell or PEM electrolyzer) generation of hydrogen and oxygen gas, in which the oxygen and hydrogen traps 25, 29 enclose the coalescing filter material 26, 30 within a sleeve 50. The sleeve 50 may be made of a plastic, ceramic or metal material suitable for exposure to oxygen or hydrogen gases. The sleeve 50 defines a plurality of openings 52, and such openings may be any arbitrary pattern of penetrations that provides sufficient open area so as to not impede the ingress or passage of the respective hydrogen or oxygen gases therethrough and into the filter material contained in the sleeve. The coalescing filter material may be pleated, filamentary or porous materials as described above.

The illustrated sleeve 50 is cylindrical, and FIG. 9 further illustrates in partially cut-away view an alternate embodiment of a second moisture dryer in which a second cylindrical sleeve 54 coaxially mounts relative to the sleeve 50 for relative movement as discussed below. In this embodiment, the sleeve 50 includes a threaded member 56 extending outward and receives a nut 58. The outer, or second, sleeve 54 defines openings 60, or penetrations, which may be any arbitrary pattern of penetrations, constrained by the openings providing sufficient open area so as to not impede the passage of the hydrogen or oxygen gases that pass through the outer or second sleeve 54. The sleeve 54 includes a receiving slot 62 open at a first edge and a transverse guide slot 64. The threaded member 56 is received through the receiving slot 62 and into the guide slot 64. By rotating 66 the outer sleeve 54 relative to the inner sleeve 50, the opening 52, 60 patterns of the sleeve wall penetrations exhibit greater or lesser amounts of overlap. This regulates the available open area of the total flow path for the hydrogen or oxygen gases flowing from the respective hydrogen and oxygen traps 25, 29 to the respective gas exit ports 32, 34. The threaded member 56 moving in the guide slot 62 guides the rotation of the sleeves. By turning the outer sleeve 54 relative to the inner sleeve 50, and then fixing the relation by the nut 58 on the threaded member 56, the amount of moisture that is allowed to escape can be managed, and the traps may be ‘tuned’ to the particular needs of the engine.

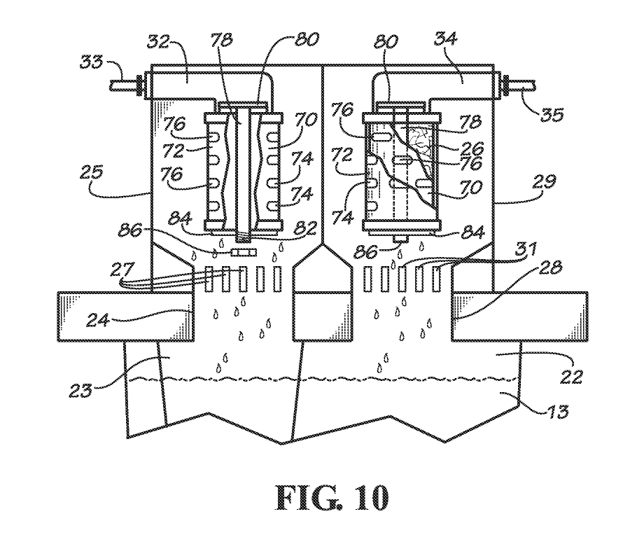

FIG. 10 illustrates an alternate embodiment having coaxial inner sleeve 70 and outer sleeve 72 each defining respective openings 74, 76 in the wall of the sleeve. The filter material 26 and the sleeves 70, 72 mount on a coaxial spindle or shaft 78 that descends through the center of the gas trap assembly from a perforated support 80. The shaft 78 terminates in connector for securing the three components in place, suspended on the spindle. The perforated support provides stiffness and structural integrity to allow the spindle or shaft to carry the three components securely, yet provide for free passage of oxygen or hydrogen gas exiting from the low side of the traps to their respective gas ports 32, 34. The perforations may be of any arbitrary size and shape. In the illustrated embodiment, the shaft 78 terminates in a threaded distal end 82. The shaft 78 receives a flat disc or washer 84 and threaded retention nut 86 that holds the three components against a surface of the top or lid. The disc or washer 84 provides a flat sealing surface to ensure that gas transport occurs only through the radial direction of the assembly, and does not bypass the sleeves and filter to directly exit the oxygen or hydrogen gas ports 32 and 34, respectively. By turning the outer sleeve 72 relative to the inner sleeve 70, and then fixing the relation by the nut 86 on the threaded spindle shaft 78, the amount of moisture that is allowed to escape can be managed, and the traps may be ‘tuned’ to the particular needs of the engine.

In a variation of the previous embodiment, the articulation of the inner (first) filter sleeve 70 relative to the outer (second) filter sleeve 72 may be accomplished through mechanical, rather than manual means. Though the lower and upper surfaces of the inner filter sleeve 70 make flush sealing contact with a lower retention disc 84 and the upper surface of the gas separator (dryer) housing, an alternate embodiment supports the inner filter 70 on a rotatable feedthrough that isolates the oxygen gas (which contains the predominant volume of moisture) or hydrogen gas (which contains a relatively minimal volume of moisture) from the ambient environment. The feedthrough may be actuated (rotated) by a small motor to regulate the overall available area of the flow path. In one exemplary embodiment, the motor is a stepper motor that accurately controls radial position, and, therefore, regulates the total available gas flow area through the moisture trap. Further, control of the movement of the inner filter and sleeve may be responsive to other parameters from the vehicle's ECU or from the hydrogen unit's controller for the hydrogen unit. This embodiment allows closed-loop, feedback control; enabling better matching of engine and hydrogen unit parameters to combustion conditions. For example, as engine temperatures rise and risks escalation in NOx levels, the application of increased moisture may be one mechanism to mitigate the increase.

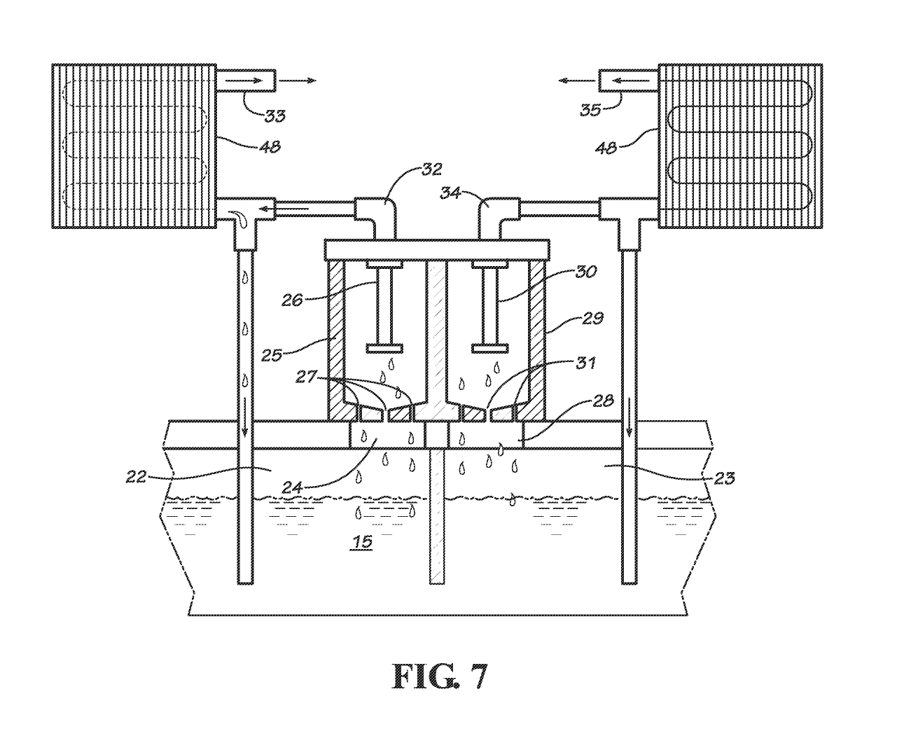

In other embodiments, other features may be added to the oxygen and hydrogen vapor traps 25, 29 to further enhance the reduction or removal of moisture from the respective gas streams. FIG. 7 illustrates an alternate embodiment that employs a condenser with finned metallic surfaces in the form of small vanes 48 to provide a large cold surface area upon which moisture droplets condense. These surfaces angle downwards to encourage the transport of moisture droplets back towards orifices that return the moisture droplets to the water tank 13. The metallic surfaces could remain cold via passive means, such as using heat-pipes to reduce fin temperature, or other active means such as employing a small pump and a chilling loop or even a small peltier device to reduce fin temperature.

The foregoing discloses an apparatus and method for management and control of water vapor in hydrogen and oxygen gas generated from fuel cells for supplemental fuel supplied to an intake manifold of an internal combustion engine. While the invention has been described with respect to various illustrative embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A method for managing moisture content of hydrogen and oxygen gas produced by a gas generator apparatus for delivery as a fuel supplement to an intake manifold of an internal combustion engine, comprising the steps of:
(a) providing a flow of process water from a supply thereof held within a supply body to an apparatus for generating hydrogen and oxygen gas;
(b) generating from the process water separate flows of hydrogen gas and oxygen gas each having a respective first moisture content;
(c) communicating the moisture content hydrogen gas to a hydrogen header space within the body, wherein at least some of the moisture content thereof forms droplets and falls into the process water within the supply body yielding a dried hydrogen gas having a second moisture content, the second moisture content less than the first moisture content thereof;
(d) communicating the moisture content oxygen gas to an oxygen header space within the supply body, wherein at least some of the moisture content thereof forms droplets and falls into the process water within the supply body yielding a dried oxygen gas having a second moisture content, the second moisture content less than the first moisture content thereof; and
(e) communicating the dried hydrogen gas and the dried oxygen gas to an intake manifold of an internal combustion engine for a fuel supplement during operation of the internal combustion engine.

2. The method as recited in claim 1, wherein step (a) providing the flow comprises pumping a portion of the process water through an outlet of the supply body to the gas generation apparatus.

3. The method as recited in claim 2, further comprising the step of filtering the process water before providing the process water to the gas generation apparatus.

4. The method as recited in claim 1, further comprising the step of filtering the process water before providing the process water to the gas generation apparatus.

5. The method as recited in claim 1, wherein the gas generation apparatus uses the provided process water in a chemical Faraday electrolysis process to generate the flows of hydrogen gas and oxygen gas.

6. The method as recited in claim 1, wherein the gas generation apparatus uses the provided process water process using a proton exchange membrane to generate the flows of hydrogen gas and oxygen gas.

7. The method as recited in claim 1, further comprising the step of a further drying of the dried hydrogen gas to have a third moisture content, the third moisture content less than the second moisture content thereof.

8. The method as recited in claim 7, wherein the step of further drying comprises the steps of:
communicating the dried hydrogen gas through a trap;
coalescing at least a second portion of the moisture content thereof within the trap;
communicating the coalesced moisture through an orifice in the trap to the hydrogen header-space of the supply body for commingling with the process water therein; and
communicating the dried hydrogen gas as a further dried hydrogen gas to the intake manifold of the internal combustion engine.

9. The method as recited in claim 8, wherein the step coalescing comprises exposing the dried hydrogen gas to a coalescing filter material within the trap.

10. The method as recited in claim 8, wherein the trap comprises a condensing coil or surface.

11. The method as recited in claim 1, further comprising the step of a further drying of the dried oxygen gas to have a third moisture content, the third moisture content less than the second moisture content thereof.

12. The method as recited in claim 11, wherein the step of further drying of the dried oxygen gas comprises the steps of:
communicating the dried oxygen gas through a trap;
coalescing at least a second portion of the moisture content thereof within the trap;
communicating the coalesced moisture through an orifice into the oxygen header-space of the supply body for commingling with the process water therein; and
communicating the dried oxygen gas as a further dried oxygen gas to the intake manifold of the internal combustion engine.

13. The method as recited in claim 12 wherein the step coalescing comprises exposing the dried oxygen gas to a coalescing filter material within the trap.

14. The method as recited in claim 12, wherein the trap comprises a condensing coil or surface.

15. The method as recited in claim 1, further comprising the step of providing a barrier extending from a cover of the supply body to a distal end proximate a bottom of the supply body to define a gap therebetween, for defining the hydrogen header space and the oxygen header space, the gap providing for fluidic communication of the process water therein between the hydrogen-receiving portion and the oxygen-receiving portion of the supply body.

16. The method as recited in claim 1, further comprising the step of providing a common supply connector extending from the supply body and having separate channels therein for communicating the hydrogen gas flow and the oxygen gas flow to the intake manifold.

17. The method as recited in claim 1, further comprising the step of operating the apparatus for generating hydrogen gas and oxygen gas in response a fuel demand signal from an internal combustion engine.

18. The method as recited in claim 1, wherein the moisture content hydrogen gas generated in step (b) has a first pressure and the hydrogen header space has a second pressure that is less than the first pressure.

19. The method as recited in claim 1, wherein the moisture content oxygen gas generated in step (b) has a first pressure and the oxygen header space has a second pressure that is less than the first pressure.

20. A system for managing moisture content of hydrogen and oxygen gas produced by a gas generator apparatus for delivery as a fuel supplement to an intake manifold of an internal combustion engine, comprising:
a supply body for holding a volume of a process water;
an apparatus for generating hydrogen gas and oxygen gas from a flow of the process water, the generated hydrogen gas and generated oxygen gas each having a respective first moisture content;
a hydrogen header space in the supply body receiving the generated hydrogen gas therein and communicating therefrom a dried hydrogen gas, wherein at least some of the moisture content of the generated hydrogen gas forms droplets and falls into the process water within the supply body yielding the dried hydrogen gas having a second moisture content, the second moisture content less than the first moisture content thereof;
an oxygen header space in the supply body receiving the generated oxygen gas therein and communicating therefrom a dried oxygen gas, wherein at least some of the moisture content of the generated oxygen gas forms droplets and falls into the process water within the supply body yielding the dried oxygen gas having a second moisture content, the second moisture content less than the first moisture content thereof;
a hydrogen gas supply line communicating the dried hydrogen gas to an intake manifold of an internal combustion engine for a fuel supplement during operation of the internal combustion engine; and
an oxygen gas supply line communicating the dried oxygen gas to an intake manifold of an internal combustion engine for a fuel supplement during operation of the internal combustion engine.

21. The system as recited in claim 20, further comprising a pump for pumping a portion of the process water through an outlet of the supply body to the gas generation apparatus.

22. The system as recited in claim 21, further comprising a filter disposed between the pump and the gas generation apparatus.

23. The system as recited in claim 20, further comprising a filter disposed between the supply body and the gas generation apparatus.

24. The system as recited in claim 20, wherein the gas generation apparatus uses the provided process water in a chemical Faraday electrolysis process to generate the flows of hydrogen gas and oxygen gas therefrom.

25. The system as recited in claim 20, wherein the gas generation apparatus uses a proton exchange membrane to generate the flows of hydrogen gas and oxygen gas.

26. The system as recited in claim 18, further comprising:
a trap for further drying of the dried hydrogen gas to have a third moisture content by coalescing a second portion of the moisture content, the third moisture content less than the second moisture content thereof; and
an outlet from the trap for communicating the coalesced portion of the moisture content into the process water within the supply body.

27. The system as recited in claim 26, wherein the trap comprises:
an inlet for receiving the dried hydrogen gas;
a chamber therein for coalescing at least a second portion of the moisture content thereof; and
an outlet therefrom for communicating the further dried hydrogen gas to the intake manifold of the internal combustion engine.

28. The system as recited in claim 27 further comprising a coalescing filter material within the trap.

29. The system as recited in claim 25, wherein the trap comprises a condensing coil

30. The system as recited in claim 20, further comprising:
a trap for further drying of the dried oxygen gas to have a third moisture content by coalescing a second portion of the moisture content, the third moisture content less than the second moisture content thereof; and
an outlet from the trap for communicating the coalesced portion of the moisture content into the process water within the supply body.

31. The system as recited in claim 20, wherein the trap comprises:
an inlet for receiving the dried oxygen gas;
a chamber therein for coalescing at least a second portion of the moisture content thereof; and
an outlet therefrom for communicating the further dried oxygen gas to the intake manifold of the internal combustion engine.

32. The system as recited in claim 31, further comprising a coalescing filter material within the trap.

33. The system as recited in claim 31 wherein the step coalescing comprises exposing the dried oxygen gas to a coalescing filter material within the trap.

34. The system as recited in claim 31, wherein the trap comprises a condensing coil or surface.

35. The system as recited in claim 20, further comprising a barrier disposed in the supply body and separating the hydrogen header-space and the oxygen header-space.

36. The system as recited in claim 35, wherein the supply tank has a hydrogen-receiving portion and an oxygen-receiving portion defined by the barrier that extends between a cover plate of the supply body to a distal end proximate a bottom of the supply body to define a gap therebetween for fluidic communication of the process water therein between the hydrogen-receiving portion and the oxygen-receiving portion.

37. The system as recited in claim 20, further comprising a common supply connector extending from the supply body and having separate channels for the hydrogen gas flow and the oxygen gas flow.

38. The system as recited in claim 20, further comprising a microprocessor configured for receiving a fuel demand signal from an internal combustion engine and for operating the apparatus for generating hydrogen gas and oxygen gas in response thereto.

39. The system as recited in claim 20, wherein the generated moisture content hydrogen gas has a first pressure and the hydrogen header space has a second pressure that is less than the first pressure.

40. The system as recited in claim 20, wherein the generated moisture content oxygen gas has a first pressure and the oxygen header space has a second pressure that is less than the first pressure.
